(19) United States
(12) Patent Application Publication
(10) Pub. No.: US 2026/0261341 A1
(43) Pub. Date: Sep. 3, 2026

(54) Rapid Satellite Acquisition for Laser Communications

(71) Applicant: The Boeing Company, Arlington, VA (US)

(72) Inventors: Nathan D. Hiller, Irvine, CA (US); Stephen G. Lambert, Maryland Heights, MO (US); Brian K. Pheiffer, Palos Verdes Est., CA (US)

(21) Appl. No.: 19/068,762

(22) Filed: Mar. 3, 2025

(51) Int. Cl. H04B 10/118; H04B 10/50

(52) U.S. Cl. CPC H04B 10/118; H04B 10/503

(57) ABSTRACT

A method for directing a laser beam. A laser beam generator is controlled to direct the laser beam to scan an initial uncertainty area for a receiving terminal. The laser beam generator is controlled to direct the laser beam at a focused uncertainty area within the initial uncertainty area in response to receiving a wireless transmission containing a timestamp identifying a detection time for a detection of the laser beam by the receiving terminal.

### STATEMENT OF GOVERNMENT INTEREST

This invention was made with United States Government support. The Government has certain rights in the invention.

### BACKGROUND INFORMATION

### 1. Field

The present disclosure relates generally to communications and in particular, to satellite communications using laser beams.

### 2. Background

Communication at high data rates between communications terminals can be laser based. These terminals can include platforms such as satellites, ground stations, vehicles, ships, aircraft, and high altitude platform systems (HAPSs). Data is transmitted using laser beams that enable high speed low latency data communications. These laser beams are used to form line of sight communications links.

The establishment of these laser based communications links involve precisely pointing laser beams at the communications terminals to establish communications links. For example, a communications terminal such as a receiving satellite receives a laser beam from a transmitting communications terminal, such as another satellite is in an acquisition phase for establishing a communications link between these two satellites.

The receiving satellite has a mirror and a quad cell sensor. The mirror is a steering mechanism to direct the laser beam at the quad cell sensor on the satellite for finer alignment. When the laser beam is in a linear region of the quad cell sensor, a direction of the incoming laser from the transmitting satellite can be determined with a desired level of accuracy.

A direction of the laser beam from the transmitting satellite can be used to determine the position of the transmitting satellite by mapping the relationship between mirror rotation angles and where the laser beam is detected on the quad cell sensor. A model of the optical geometry, including the distances and angles involved, can be used to calculate spatial coordinates for the transmitting satellite. This information can be used by the receiving satellite to transmit a return laser beam to the transmitting satellite to establish an optical communications link between these two satellites.

### SUMMARY

An embodiment of the present disclosure provides a laser communications system comprising a transmitting terminal comprising a laser beam generator configured to transmit a laser beam; a receiver configured to receive a wireless transmission; and a controller. The controller is configured to perform operations comprising controlling the laser beam generator to direct the laser beam to scan an initial uncertainty area for a receiving terminal and controlling the laser beam generator to direct the laser beam at a focused uncertainty area within the initial uncertainty area in response to the receiver receiving the wireless transmission containing a timestamp identifying a detection time for a detection of the laser beam by the receiving terminal.

Another embodiment of the present disclosure provides a receiving terminal comprising a wireless transmitter configured to transmit a wireless transmission; a laser beam sensor system configured to detect a laser beam transmitted from a transmitting terminal; and a receiving controller. The receiving controller is configured to perform operations comprising generating a timestamp identifying a detection time for a detection of the laser beam from a transmitting terminal in response to the laser beam sensor system detecting the laser beam and transmitting the timestamp in the wireless transmission to the transmitting terminal using the wireless transmitter.

Yet another embodiment of the present disclosure provides a method for directing a laser beam. A laser beam generator is controlled to direct the laser beam to scan an initial uncertainty area for a receiving terminal. The laser beam generator is controlled to direct the laser beam at a focused uncertainty area within the initial uncertainty area in response to receiving a wireless transmission containing a timestamp identifying a detection time for a detection of the laser beam by the receiving terminal.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a pictorial representation of a communications network in which illustrative embodiments may be implemented;

FIG. 2 is an illustration of a block diagram of a communications environment in accordance with an illustrative embodiment;

FIG. 3 is an illustration of a diagram for directing a laser beam towards a receiving satellite in accordance with an illustrative embodiment;

FIG. 4 is an illustration of uncertainty areas in accordance with an illustrative embodiment;

FIG. 5 is an illustration of scanning an uncertainty area in accordance with an illustrative embodiment;

FIG. 6 is an illustration of uncertainty areas based on beam divergences in accordance with an illustrative embodiment;

FIG. 7 is an illustration of uncertainties used to determine an uncertainty area in accordance with an illustrative embodiment;

FIG. 8 is an illustration of a flowchart of a process to direct a laser beam at a receiving satellite from a transmitting satellite in accordance with an illustrative environment;

FIG. 9 is an illustration of a flowchart of a process for directing a laser beam in accordance with an illustrative embodiment;

FIG. 10 is an illustration of a flowchart of a process for controlling a laser beam generator to direct the laser beam at the focused uncertainty area in accordance with an illustrative embodiment;

FIG. 11 is an illustration of a flowchart of a process for directing a laser beam at a focused uncertainty area in accordance with an illustrative embodiment; and

FIG. 12 is an illustration of a block diagram of a data processing system in accordance with an illustrative embodiment.

### DETAILED DESCRIPTION

The illustrative embodiments recognize and take into account one or more different considerations as described herein. For example, high data rate satellite constellations require the exchange of precisely pointed laser beams in establishing communications links between the satellites in these satellite constellations. The great distances separating satellites can result in an initial acquisition phase that is time-consuming. The acquisition phase involves a transmitting satellite that transmits a laser beam to scan an area in which the receiving satellite is expected to be located. This area is also referred to as an uncertainty area.

It is desirable to have a scanning method that reduces the amount of time needed for the laser beam transmitted by the transmitting satellite to be detected by a receiving satellite with which a communications link is to be established. For example, the satellite transmits a laser beam and sweeps the laser beam in a spiral pattern to cover the uncertainty area in the vicinity of the receiving satellite. Eventually, this laser beam passes over the telescope aperture of the receiving satellite and can be detected by the quad cell sensor in the receiving satellites. The receiving satellite focuses the laser beam onto a quad cell where it is detected. The telescope for the receiving satellite can be adjusted to better point at the transmitting satellite using detection of the laser been output by the quad cell sensor detection output.

This adjustment step is typically performed at least five to six times to obtain sufficient data to determine the direction of the laser beam and the location of the transmitting satellite. The number of laser beam detections needed results from adjustments to the telescope to center the focal point of the laser beam on the linear region of the quad cell sensor.

As used herein, a “number of” when used with reference items means one or more items. For example, a number of detections is one or more detections. When the laser beam is detected in this linear region, the location of the transmitting satellite can be determined.

In this process, these five to six detections with adjustments in directing the laser beam are performed before the laser beam completely passes the telescope aperture of the receiving satellite.

This current technique is very slow because of the scan speed used for the laser beam in this acquisition phase. The scanning of the laser beam in the spiral pattern involves moving the laser beam at a sufficiently slow speed to enable in the receiving satellite to have sufficient time to complete at least five beam detection and telescope adjustments before the laser beam is no longer directed at the telescope aperture.

The illustrative examples recognize that the speed is currently used in scanning all portions of the uncertainty area even though 99% of the time the transmitted beam is not passing over the telescope aperture of the receiving satellite. This type of scanning is inefficient. The total scan time for scanning an uncertainty area using a spiral pattern can take 100 seconds.

It is desirable to reduce the amount of time needed to scan the uncertainty area to increase the speed at which communications can be established between different communications terminals. In one illustrative example, the scan speed can be increased in scanning an initial uncertainty area with a scan speed that is faster than currently used. Once a detection of the laser beam is made by the receiving satellite, this detection can be used to determine a second uncertainty area that is smaller than the initial uncertainty area. As a result, a smaller uncertainty area can be determined, enabling redirecting the laser beam to scan a smaller area. Depending on how much of the initial uncertainty area has been scanned, the amount of scanning time can be greatly reduced by refocusing the scanning to a smaller area in the focused uncertainty area.

Further, this laser beam can be pointed at the second uncertainty area to scan this area at a slower speed that enables the additional detections and adjustments needed to determine the direction of the laser beam from the transmitting satellite and from that direction the location of the transmitted satellite. Thus, the amount of time needed to scan an uncertainty area is reduced through using a faster scan speed that does not enable five to six detections for initial acquisition.

Thus, the illustrative examples provide a method, apparatus, system, and computer program product for directing a laser beam. In one example, a method directs a laser beam scan for a receiving terminal. A laser beam generator is controlled to direct the laser beam to scan an initial uncertainty area for a receiving terminal. The laser beam generator is controlled to direct the laser beam at a focused uncertainty area within the initial uncertainty area in response to receiving a wireless transmission containing a timestamp identifying a detection time for a detection of the laser beam by the receiving terminal.

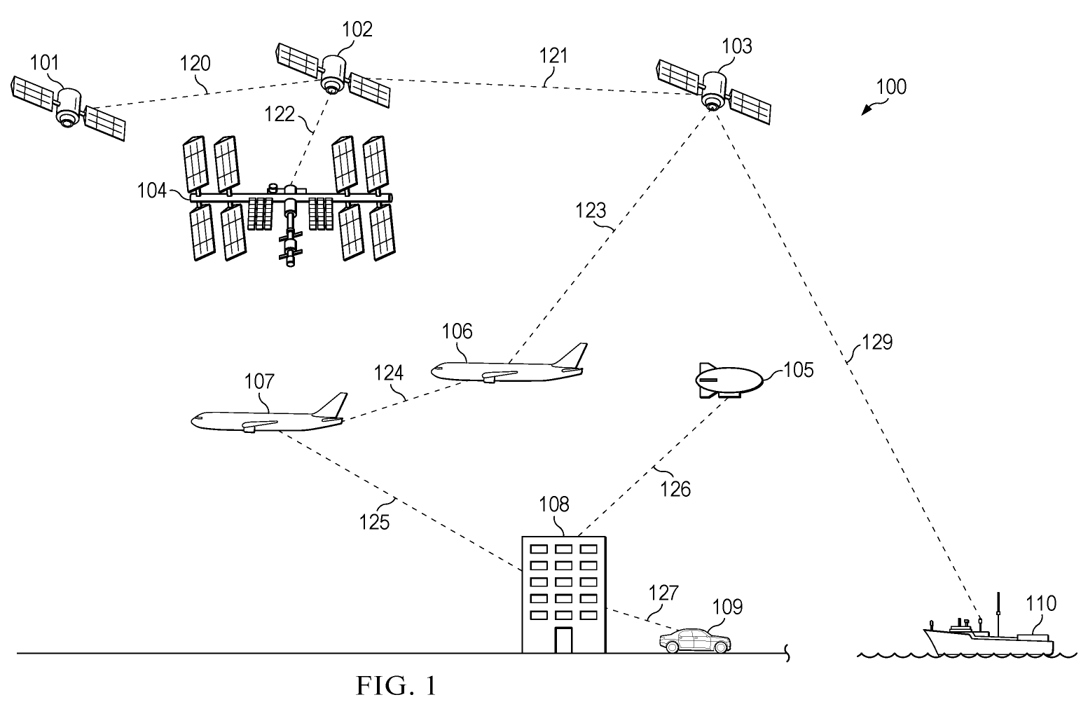

With reference now to the figures and, in particular, with reference to FIG. 1, an illustration of a pictorial representation of a communications network is depicted in which illustrative embodiments may be implemented. In this example, communications network 100 includes a number of communications terminals. As depicted, these communications terminals are satellite 101, satellite 102, satellite 103, space station 104, high altitude platform system (HAPS) 105, airplane 106, airplane 107, building 108, car 109, and surface ship 110.

These different communications terminals exchange information using communications links. In this example, satellite 101 and satellite 102 exchange information using communications link 120. Satellite 102 and satellite 103 communicate using communications link 121. Satellite 102 also communicates with space station 104 using communications link 122.

Further in this example, satellite 103 communicates with airplane 106 using communications link 123 and with surface ship 110 using communications link 129. Communications link 124 provides communications between airplane 106 and airplane 107. In this example, airplane 107 also communicates with building 108 using communications link 125.

High altitude platform system (HAPS) 105 communicates with building 108 using communications link 126. Building 108 communicates with car 109 using communications link 127.

In this depicted example, these communications links are high-speed communications links in the form of laser beams. The communications links can be unidirectional or bidirectional. Each direction of communications involves a laser beam being transmitted from one communications terminal to another communications terminal. The communications terminal transmitting the laser beam is referred to as a transmitter communications terminal, and the communications terminal receiving the laser beam is referred to as the receiver communications terminal.

In these examples, increasing the speed at which communications links can be established can improve the speed at which data transmissions can occur. Receivers in these communications terminals receive laser beams pointed at the receivers. In turn, these receivers can identify the direction from which the laser beams were received and transmit return laser beams to establish the communications links.

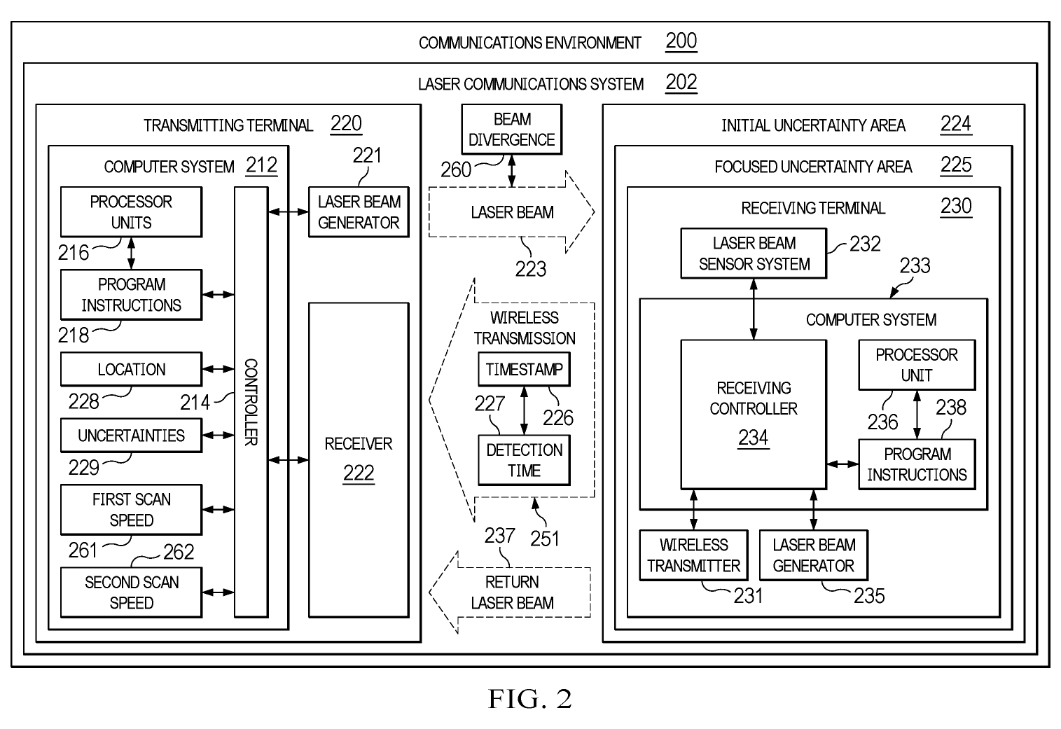

With reference now to FIG. 2, an illustration of a block diagram of a communications environment is depicted in accordance with an illustrative embodiment. In this illustrative example, communications environment 200 includes components that can be implemented in hardware such as the hardware shown in communications network 100 in FIG. 1.

In this illustrative example, laser communication system 202 in communications environment 200 comprises transmitting terminal 220 and receiving terminal 230. These terminals can take a number of different forms. For example, transmitting terminal 220 and receiving terminal 230 can be selected from a group comprising a mobile platform, a stationary platform, a land-based structure, an aquatic-based structure, a space-based structure, a surface ship, a tank, a personnel carrier, a train, a spacecraft, a space station, a satellite, a high altitude platform system, aircraft, a submarine, an automobile, a power plant, a bridge, a dam, a house, a manufacturing facility, or a building.

In this example, transmitting terminal 220 comprises a number of different components. As depicted, transmitting terminal 220 includes laser beam generator 221, receiver 222, computer system 212, and controller 214. Laser beam generator 221 is configured to transmit laser beam 223. Controller 214 is located in computer system 212.

Controller 214 can be implemented in software, hardware, firmware or a combination thereof. When software is used, the operations performed by controller 214 can be implemented in program instructions configured to run on hardware, such as a processor unit. When firmware is used, the operations performed by controller 214 can be implemented in program instructions and data and stored in persistent memory to run on a processor unit. When hardware is employed, the hardware can include circuits that operate to perform the operations in controller 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, controller 214 is configured to perform a number of different operations. For example, controller 214 controls laser beam generator 221 to direct laser beam 223 to scan initial uncertainty area 224 for receiving terminal 230.

In this depicted example, initial uncertainty area 224 is an area in space where receiving terminal 230 is expected to be located. For example, initial uncertainty area 224 can be determined using an expected position of receiving terminal 230. When receiving terminal 230 is a satellite, the expected position can be determined from orbital models and real-time tracking data. The uncertainty area around that expected position can be determined using factors such as orbital prediction errors, attitude determination inaccuracies, time synchronization discrepancies, and ephemeris data latency.

The scanning performed using laser beam 223 can take a number of forms. For example, laser beam generator 221 can be controlled by controller 214 to cause laser beam 223 to scan initial uncertainty area 224 using a pattern selected from a group comprising a spiral pattern, a raster pattern, a hexagonal pattern, and other suitable patterns.

Controller 214 controls laser beam generator 221 to direct laser beam 223 at focused uncertainty area 225 within initial uncertainty area 224 in response to receiver 222 receiving wireless transmission 251 containing timestamp 226 identifying detection time 227 for a detection of laser beam 223 by receiving terminal 230.

Wireless transmission 251 can be received in a number of different ways. For example, wireless transmission 251 can be a radio frequency transmission received directly from receiving terminal 230. In other words, receiving terminal 230 transmits wireless transmission 251 directly to receiver 222 in transmitting terminal 220. This type of transmission can be a radio frequency signal. In another example, wireless transmission 251 is a laser beam transmission received from a third terminal in communication with the transmitting terminal 220 transmitting laser beam 223 and receiving terminal 230.

In directing laser beam 223 at focused uncertainty area 225, controller 214 receives timestamp 226 identifying detection time 227 for the detection of laser beam 223 by receiving terminal 230. Further, controller 214 determines location 228 pointed to by laser beam 223 at detection time 227 using timestamp 226. In this example, location 228 can be a laser beam angle for laser beam 223 corresponding to timestamp 226.

Controller 214 determines focused uncertainty area 225 using location 228 and a number of uncertainties 229 for location 228 identified using timestamp 226. Focused uncertainty area 225 is a smaller area than initial uncertainty area 224. In this example, the number of uncertainties 229 can be selected from at least one of a clock synchronization error or a point-ahead-error. Controller 214 controls laser beam generator 221 to direct laser beam 223 at focused uncertainty area 225 in response to determining the focused uncertainty area 225.

The controlling of laser beam generator 221 by controller 214 to direct laser beam 223 at focused uncertainty area 225 can take a number of different forms. For example, controller 214 can control laser beam generator 221 to direct laser beam 223 to scan the focused uncertainty area 225 in response to determining that the focused uncertainty area is larger than beam divergence 260 of laser beam 223.

In this example, beam divergence 260 is a spreading of laser beam 223 as laser beam 223 propagates, resulting in an increase in the diameter of laser beam 223. This spreading can be used to determine the approximate diameter of laser beam 223 when it reaches focused uncertainty area 225. This diameter can be for the beam spot at focused uncertainty area 225.

In this illustrative example, first scan speed 261 is used in directing laser beam 223 to scan initial uncertainty area 224. Directing laser beam 223 to scan focused uncertainty area 225 is performed using second scan speed 262. Second scan speed 262 is slower than first scan speed 261. In this example, focused uncertainty area 225 is scanned using a pattern selected from a group comprising a spiral pattern, a raster pattern, a hexagonal pattern, and other suitable patterns.

Controller 214 also controls laser beam generator 221 to direct laser beam 223 to point to focused uncertainty area 225 in response to determining that focused uncertainty area 225 is equal to or smaller than beam divergence 260 of laser beam 223. In this case, beam divergence 260 results in laser beam 223 covering focused uncertainty area 225 when laser beam 223 is pointed at focused uncertainty area 225. As a result, scanning of laser beam 223 is unnecessary in directing laser beam 223 at focused uncertainty area 225.

The initial directing of laser beam 223 to scan initial uncertainty area 224 results in a detection in which laser beam 223 illuminates receiving terminal 230. First scan speed 261 for this scan can be selected as a speed that is faster as compared to current scanning techniques that provide sufficient time for five or more detections of a laser beam.

In this illustrative example, first scan speed 261 can be selected to enable a single detection rather than multiple detections. The scan speed can be reduced from first scan speed 261 to second scan speed 262 after receiving terminal 230 has detected laser beam 223. This second speed is slower than first scan speed 261. Second scan speed 262 is selected to enable five or more detections of laser beam 223 by receiving terminal 230 when laser beam 223 is directed at focused uncertainty area 225 to scan focused uncertainty area 225.

In this example, receiving terminal 230 is comprised of a number of different components. In this example, receiving terminal 230 includes wireless transmitter 231, laser beam sensor system 232, computer system 233, laser beam generator 235, and receiving controller 234.

Wireless transmitter 231 is configured to transmit wireless transmission 251. Laser beam sensor system 232 is configured to detect laser beam 223 transmitted by transmitting terminal 220. Laser beam sensor system 232 can take a number of different forms. For example, laser beam sensor system 232 can be selected from at least one of a quad cell sensor and mirror; a focal plane array; an avalanche photodiode system; or other suitable types of sensors. For example, sensors such as those that can detect laser beam 223 and focus the laser beam 223 onto a surface of the laser beam detector can be used. With this type of sensor, the angle at which laser beam 223 is detected can be used to determine the direction from which laser beam 223 is received. In these examples, five or more detections are typically used to accurately determine the angle which laser beam 223 is detected.

Receiving controller 234 is located in the computer system 233. As depicted, computer system 233 includes a number of processor units 236 that are capable of executing program instructions 238 implementing processes in the illustrative examples. In other words, program instructions 238 are computer-readable program instructions.

In this example, receiving controller 234 is configured to perform a number of different operations. For example, receiving controller 234 generates timestamp 226 identifying detection time 227 for the detection of laser beam 223 by receiving terminal 230 in response to the laser beam sensor system 232 detecting laser beam 223. Receiving controller 234 transmits timestamp 226 in wireless transmission 251 to receiver 222 for transmitting terminal 220.

When a sufficient number of detections is performed to determine the angle at which laser beam 223 is received, receiving controller 234 can control laser beam generator 235 to transmit return laser beam 237 in response to detecting laser beam 223 in the linear region in laser beam sensor system 232. In this example, the linear region is in a quad cell sensor in laser beam sensor system 232. In this example, the linear region is a central area where the output of the four quadrants of quad cell is directly proportional to the position of the beam spot on the quad sensor which through coordinate transformations is related to the receive angle of the detected laser beam, enabling accurate measurement of the received line of sight angle.

In one illustrative example, one or more technical solutions are present that overcome a technical problem with the amount of time used in establishing a communications link between two terminals such as has two satellites. In the different illustrative examples, an initial uncertainty area in which the terminal is expected is scanned. In response to receiving a timestamp indicating a detection by the receiving terminal, a focused uncertainty area is determined using the timestamp. This focused uncertainty area is smaller than the initial uncertainty area. The search for the receiving terminal by the transmitting terminal can continue in a smaller uncertainty area in these examples.

Further, the scan speed for the initial search can be performed at a faster speed than current scan speeds used by current techniques to establish communications. This faster speed is enabled by only needing a single detection rather than multiple detections. Once the focused uncertainty area is determined, a slower scan speed is selected. The slower scan speed is one that is sufficient to enable the number of detections needed for the receiving terminal to determine the direction from which the laser beam is transmitted. This direction can be used to determine the location of the transmitting terminal enabling the receiving terminal to transmit a return laser beam to the transmitting terminal as part of the acquisition process.

In the illustrative examples, the time savings from using faster speed for initial uncertainty are 224 outweigh the time used for the single detection, sending wireless transmission 251, and redirecting laser beam 223 two scan focused uncertainty area 225. In other words, the time for these operations can result in a much lower amount of time needed for the detections in the initial acquisition phase.

The illustration of communications environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more terminals can also be present in addition to transmitting terminal 220 and receiving terminal 230. These other terminals can also establish communications with each other or with these depicted terminals using an initial uncertainty area and a focused uncertainty area in the manner described in these examples.

As another example, five detections are performed for focused uncertainty area 225. Other numbers of detections can be performed in other examples depending on the speed of the particular mechanism used to detect and make adjustments for detecting laser beam 223.

In another example, one clock is present on the transmitting satellite. When the receiving satellite detects the laser beam, the receiving satellite sends a blank signal back to the transmitting satellite. The transmitting satellite detects this return signal and records it records the time (time-of arrival). The transmitting satellite then calculates the “time-stamp” by taking this “time-of-arrival” and subtracting the two-way propagation time between the satellites and the receiving satellite’s detection and response times.

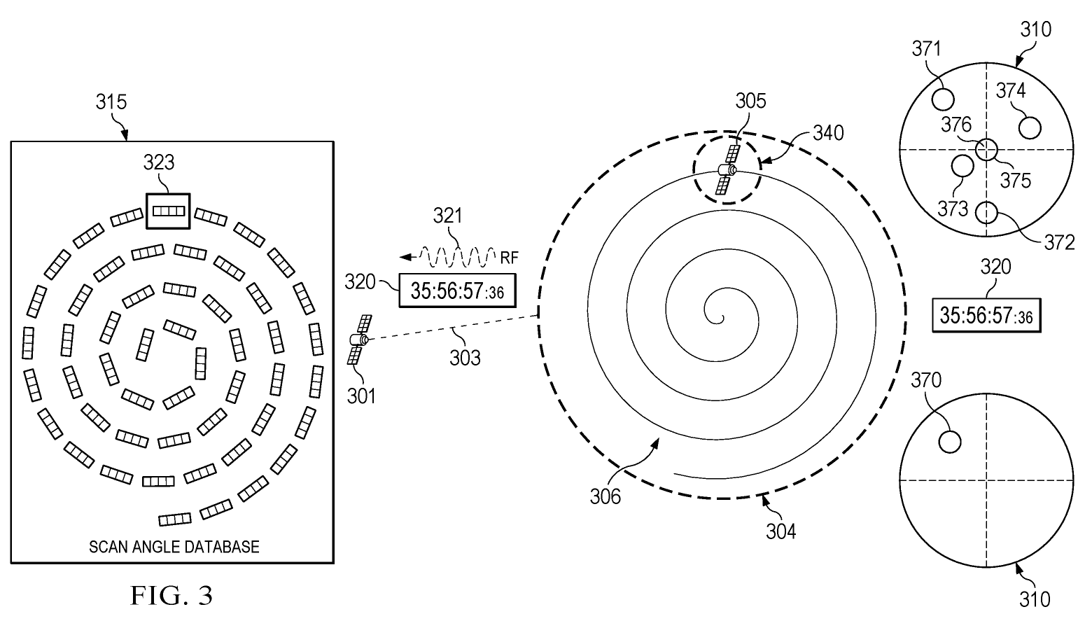

In FIG. 3, an illustration of a diagram for directing a laser beam towards a receiving satellite is depicted in accordance with an illustrative embodiment. In the illustrative example, transmitting satellite 301 directs laser beam 303 to scan initial uncertainty area 304 in which receiving satellite 305 is expected to be present. In this example, a scanning of initial uncertainty area 304 using laser beam 303 is performed using spiral scan 306. The scan speed of laser beam 303 is set based on n=1. In this example n is a number of detections that can occur while the laser beam is passing through an aperture to a laser beam sensor. In other words, the speed of laser beam 303 is such that receiving satellite 305 can perform a single detect laser beam 303 before laser beam 303 moves past a telescope aperture in receiving satellite 305. This speed is fast enough that additional detections are not possible before the laser beam no longer illuminates the telescope aperture to enable another detection.

This scan speed is faster than scan speeds using current techniques. Current techniques can use a scan speed of n=5 or n=6. The faster speed used in this example does not enable receiving satellite 305 to make five detections to be able to determine the direction from which laser beam 303 originates.

When receiving satellite 305 detects laser beam 303, detection 370 is made by quad cell sensor 310. As depicted, this detection occurs in a quad cell sensor 310 but not in the linear region of this sensor. In this example, the linear region is a region around the center of quad cell sensor 310. In this example, the speed at which laser beam 303 moves for scanning provides insufficient time to make additional detections.

In this example, both transmitting satellite 301 and receiving satellite 305 have synchronized clocks. Receiving satellite 305 generates timestamp 320 which identifies the time at which receiving satellite 305 detects laser beam 303. This timestamp is transmitted in a wireless transmission that is in the form of radio frequency signal 321.

Transmitting satellite 301 receives radio frequency signal 321 containing timestamp 320. In this example, transmitting satellite 301 tracks the location where laser beam 303 was pointing during the spiral scan over time. In this example, this location information takes the form of scan angles associated with timestamps for when different scan angles are used to scan initial uncertainty area 304. A scan angle is the angle at which laser beam 303 is transmitted to perform a scan.

For example, timestamp 320 is associated with scan angle 323 in scan angle database 315. In this example, focused uncertainty area 340 is determined based on the location identified for detection at timestamp 320. In this example, focused uncertainty area 340 is within initial uncertainty area 304 and is smaller in size than initial uncertainty area 304.

Transmitting satellite 301 transmits laser beam 303 to scan focused uncertainty area 340. The scan can be performed at a slower speed as compared to the scan speed used for initial uncertainty area 304. For example, a scan speed of n=5 can be used in which the scan speed is selected such that receiving satellite 305 can make five detections of laser beam 303 before laser beam 303 no longer illuminates the telescope aperture for receiving satellite 305. As depicted, five detections can be made by quad cell sensor 310 before laser beam 303 goes past the telescope aperture for receiving satellite 305 and no longer can be detected by quad cell sensor 310. For example, these detections are detections in the area of detection D1371, detection D2372, detection D3373, detection D4374, and detection D5375. The last detection, detection D5375 occurs in linear region 376 of quad cell sensor 310.

Thus, the amount of time needed to scan and locate receiving satellite 305 is less than current techniques. This reduction in time results from using a faster scan speed for scanning initial uncertainty area 304. The slower scan speed used in current techniques is used to scan a small area, focused uncertainty area 340.

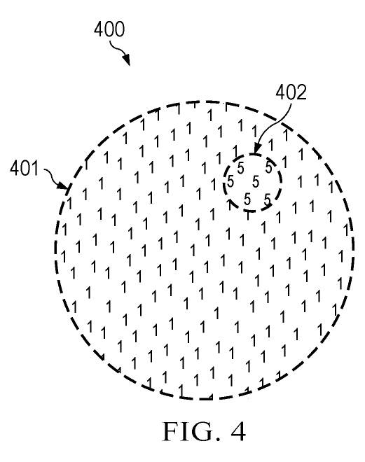

Turning next to FIG. 4, an illustration of uncertainty areas is depicted in accordance with an illustrative embodiment. In this illustrative example, uncertainty areas 400 comprise initial uncertainty area 401 and focused uncertainty area 402. Initial uncertainty area 401 is an example of an implementation for initial uncertainty area 224 in FIG. 2. Focused uncertainty area 402 is an example of an implementation for focused uncertainty area 225 in FIG. 2.

As depicted, focused uncertainty area 402 is smaller than initial uncertainty area and is located within initial uncertainty area 401.

In this illustrative example, the scan speed for a laser beam scanning initial uncertainty area is n=1. In other words, the scan speed selected enables a single detection of the laser beam by a receiving terminal such as a satellite. In this case, the speed at which the laser beam moves past the telescope aperture is selected to provide time sufficient for a single detection. In this example, the telescope aperture allows light to illuminate a laser beam sensor such as a quad cell sensor. In other words, the speed at which the laser beam scans initial uncertainty area 401 is too fast to allow for more than one detection of the laser beam before the laser beam spot moves past the receiving terminal and can no longer be detected.

When focused uncertainty area 402 is determined, the speed at which the laser beam moves allows for n=5. In other words, the laser beam is moved at a sufficiently slow speed that enables the receiving satellite to make five detections of the laser beam before the laser beam no longer passes through the telescope aperture of the satellite. With this amount of time, a mirror in the receiving satellite can reflect the laser beam on the quad cell sensor to move into the linear region. The mirror is controlled to move the laser beam upon each detection towards and into the linear region.

In this example, time savings are present using this type of scanning process as compared to current techniques. For example, if a time measurement interval (TMI) is 20 milliseconds and n=5 for five detections, then a single beam pass is 100 ms. The TMI is a segment of time needed for a single detection of the laser beam by the receiving terminal.

With current techniques, scan time to scan an uncertainty area can take about 100 seconds. The total time to perform the spatial acquisition of the laser linkage between the two terminals, such as satellites. With illustrative examples, the time needed for a radio frequency signal to be transmitted from the receiving satellite to the transmitting satellite is only about 2% of the total scan time of 100 seconds. This percent is based on a one-way trip of 800 ms.

The illustration of process flow for directing a laser using satellites in FIG. 3 and uncertainty areas in FIG. 4 are provided as examples and are not meant to limit the manner in which illustrative examples can be implemented. For example, the process flow for directing a laser beam can be between other terminals in addition to satellites. In another illustrative example, transmitting satellite 301 can direct a laser beam at a ground station. In yet another illustrative example, a ground station can direct a laser beam at an aircraft to establish communications. In yet other illustrative examples, a laser beam may be directed from one aircraft to another aircraft to establish communications.

In yet another illustrative example, scan speeds can be based on other n values than n=1 and n=5. For example, the scanning of initial uncertainty area 304 can performed with a scan speed based on n=2. This speed is a speed that can enable a receiving terminal to detect a laser beam two times before the laser beam moves past a telescope aperture for that terminal.

The value for n can be selected in a number of different ways. For example, an M out of N detection can be used. This detection theory considers that a laser beam is detected if the laser beam is observed at least M time out of N total observations. This theory can be used to increase the probability of detecting a laser beam while reducing the false alarms.

For example, in a first case, n set to 1 and the time measurement interval is set at 20 msec. With this case, the time it takes for the laser beam to sweep past the receiving aperture is 1 x 20 msec = 20 msec. This case has high irradiance but is slow-moving.

In a second case, M out of N detection theory shows that the same probability of detection and false alarms can be achieved by setting n to 2 and the time measurement interval to 8 msec. With this case, the time it takes for the laser beam to sweep past the receiving aperture is 2 x 8 msec = 16 msec. This case has a low irradiance but the laser beam is fast-moving.

Thus, the second case scan the initial uncertainty area 20% faster than the first case. Both cases have the same probability of detection and false alarms.

In another example, the scan speed for focused uncertainty area 302 can be n=6 or some other value that enables the receiving terminal sufficient time to make the number of detections needed to determine the direction from which the laser beam originated. In yet other illustrative examples, another structure other than a telescope aperture can be present. For example, the sensor for detecting the laser beam can be on the surface of a receiving terminal making telescope aperture unnecessary.

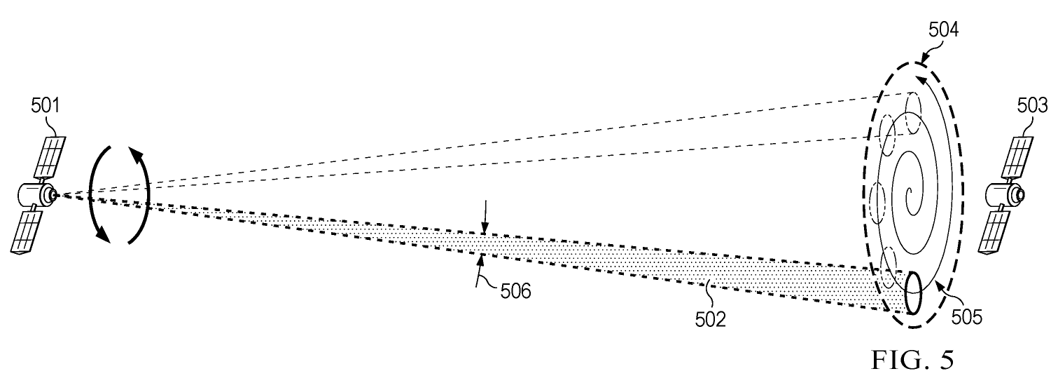

With reference to FIG. 5, an illustration of scanning an uncertainty area is depicted in accordance with an illustrative embodiment. In this illustrative example, transmitting satellite 501 transmits laser beam 502 at receiving satellite 503 that is located in uncertainty area 504. As depicted, the scanning is performed using spiral scan 505. In this example, the manner in which laser beam 502 is directed towards uncertainty area 504 can be based on beam divergence 506 for laser beam 502.

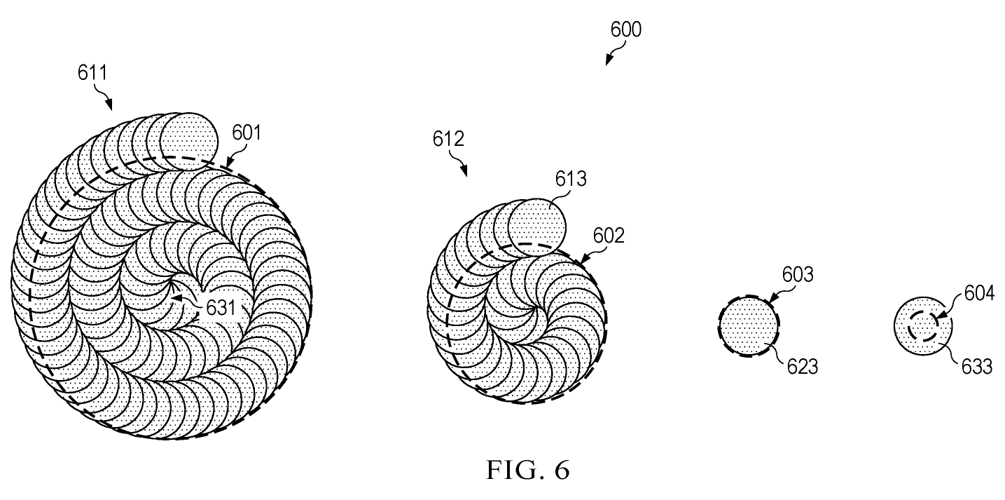

Turning next to FIG. 6, an illustration of uncertainty areas based on beam divergences is depicted in accordance with an illustrative embodiment. In this illustrative example, uncertainty areas 600 are determined and used to direct a laser beam towards a receiving terminal such as receiving satellite 503 in FIG. 5.

In this example, uncertainty areas 600 include initial uncertainty area 601, focused uncertainty area 602, focused uncertainty area 603, and focused uncertainty area 604. In this example, a laser beam has a beam spot with a size at uncertainty area based on the divergence of the laser beam.

In initial uncertainty area 601, beam spots 611 are present in a spiral pattern. The spiral pattern is generated by scanning the laser beam using a spiral scan starting from center 631 of initial uncertainty area 601. The scanning is performed to have beam spots 611 cover the area within initial uncertainty area 601 forming the spiral scan. In this example, beam spots 611 identify areas in which the laser beam illuminates initial uncertainty area 601. In this example, the scan of initial uncertainty area 601 has many rings in the spiral as compared to focus uncertainty area 602 because of the larger size of initial uncertainty area 601.

Focused uncertainty area 602 is a smaller area compared to initial uncertainty area 601. In this example, the divergence for the laser beam has beam spots 612 having a diameter that is smaller than focused uncertainty area 602. For example, focused uncertainty area 602 is larger than beam spot 613 in beam spots 612. With focused uncertainty area 602 having a size that is larger than beam spots 612, the laser beam is scanned using a spiral scan to cover the area within focused uncertainty area 602.

Next, the divergence of the laser beam results in beam spot 623 having a size that is the same as focused uncertainty area 603. As a result, the laser beam can be directed at focused uncertainty area 603 without needing to scan focused uncertainty area 603 because beam spot 623 covers the area within focused uncertainty area 603.

Further in this example, focused uncertainty area 604 is smaller than beam spot 633 for the laser beam. In this example, the laser beam is directed at focused uncertainty area 604 with beam spot 633 covering focused uncertainty area 604. As a result, the laser beam can be directed at focused uncertainty area 604 without needing to scan focused uncertainty area 604.

Thus, in these examples, scanning is performed if the beam spot resulting from the being divergence is smaller than the uncertainty area being scanned. When the uncertainty area is equal to or smaller than the beam spot, then scanning is not needed. Instead, the laser beam can be directed at the uncertainty area.

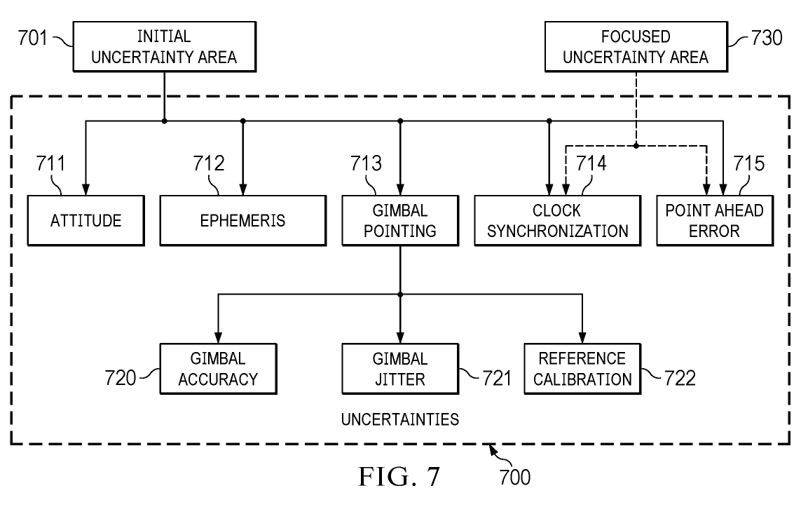

In FIG. 7, an illustration of uncertainties used to determine an uncertainty area is depicted in accordance with an illustrative embodiment. In this example, uncertainties 700 are used to determine initial uncertainty area 701. In these examples, the initial uncertainty area can start from a point or location at which the laser beam is directed. This point can be expanded into a circle or other area based on uncertainties caused by various factors. These factors include uncertainties in the transmitting satellite and uncertainties in the receiving satellite.

These uncertainties are errors that occur during the process of pointing the laser beam towards a receiving terminal. These uncertainties include attitude 711, ephemeris 712, gimbal pointing 713, clock synchronization 714 and point ahead error 715.

For example, attitude 711 is an uncertainty or inaccuracy in measuring the orientation of the transmitting satellite. Ephemeris 712 is an inaccuracy in the predicted or recorded orbital position of the satellite. If the predicted or recorded orbital position of the satellite is incorrect, then the laser beam directed at the satellite may be misdirected.

Gimbal pointing 713 is an uncertainty caused by the gimbal mechanism used to direct the laser beam. This uncertainty can be caused by inaccuracies in positioning or moving the gimbal mechanism to direct the laser beam. In this example, gimbal pointing 713 can be caused by a number of different uncertainties or errors. For example, gimbal pointing 713 can be caused by uncertainties in gimbal accuracy 720, gimbal jitter 721, and reference calibration 722.

Gimbal accuracy 720 is the error or uncertainty in how precise the gimbal can position and maintain the direction at which a laser beam is pointed. Gimbal jitter 721 is vibrations or other frequency fluctuations that occur in pointing the laser beam at a particular direction for a laser beam using a gimbal mounted system. Reference calibration 722 can result in uncertainties during the process of comparing the actual pointing direction of the gimbal with known reference locations.

Clock synchronization 714 results from an error in synchronizing the clock of the satellite transmitting the laser beam with the clock of the satellite receiving the laser beam. In this case, the timestamp received from the receiving satellite may result in an incorrect position identified for the laser beam because the timestamp is not an accurate time where the laser beam was pointing when the receiving satellite detected the laser beam.

Next, point ahead error 715 can occur when a misalignment in compensating for the relative motion between the satellite transmitting the laser beam and the satellite receiving the laser beam occurs. This type of error can occur when the angular offset for time delay due to travel time for the laser beam a relative motion of the satellites is incorrect.

Once a detection is made in initial uncertainty area 701, uncertainties 700 can be reduced. For example, attitude 711, ephemeris 712, and gimbal pointing 713, are near zero. At this time, clock synchronization 714 and point ahead error 715 are factors used to determine focused uncertainty area 730.

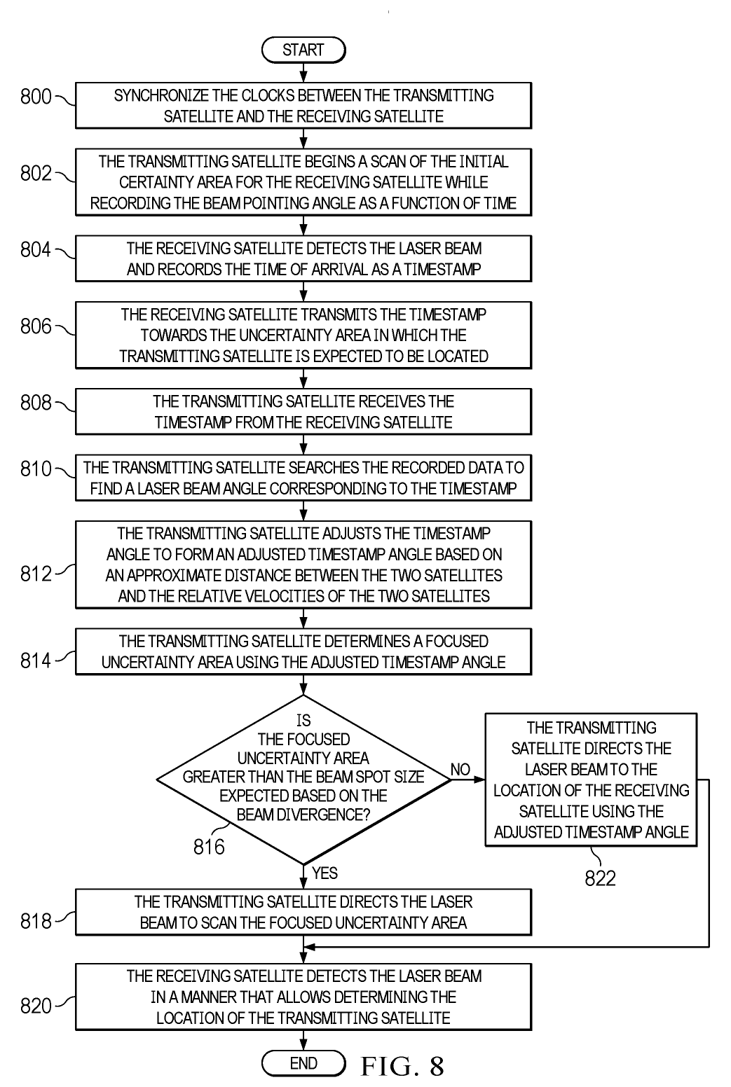

With reference next to FIG. 8, an illustration of a flowchart of a process to direct a laser beam at a receiving satellite from a transmitting satellite is depicted in accordance with an illustrative environment. The process illustrated in this flowchart can be implemented in laser communication system 202 in FIG. 2. As another illustrative example, this process can also be implemented using transmitting satellite 301 and receiving satellite 305 in FIG. 3.

The process begins by synchronizing the clocks between the transmitting satellite and the receiving satellite (operation 800). The transmitting satellite begins a scan of the initial certainty area for the receiving satellite while recording the beam pointing angle as a function of time (operation 802). In operation 802, this information can be recorded in a database, such as scan angle database 315 in FIG. 3. In this operation, scan speed for the laser beam transmitted by the transmitting satellite enables at least one TMI for aperture crossing. This aperture crossing is for a telescope aperture or other opening for a sensor that can detect the laser beam.

The receiving satellite detects the laser beam and records the time of arrival as a timestamp (operation 804). The receiving satellite transmits the timestamp towards the uncertainty area in which the transmitting satellite is expected to be located (operation 806). In operation 806, the transmission can be made using a radiofrequency signal. In some illustrative examples, the timestamp can be sent from the receiving satellite to the transmitting satellite using a number of intermediaries such as another satellite, a spacecraft, a ground station, or some other platform. The number of intermediaries can be part of an already connected network including the transmitting satellite and the receiving satellite.

The transmitting satellite receives the timestamp from the receiving satellite (operation 808). The transmitting satellite searches the recorded data to find a laser beam angle corresponding to the timestamp (operation 810). This laser beam angle can also be referred to as the timestamp angle.

The transmitting satellite adjusts the timestamp angle to form an adjusted timestamp angle based on an approximate distance between the two satellites and the relative velocities of the two satellites (operation 812). The transmitting satellite determines a focused uncertainty area using the adjusted timestamp angle (operation 814). The orbital velocities of the two satellites can be used to adjust the timestamp angle to form the adjusted timestamp angle. This adjustment is part of the point-ahead angle calculation. The rate of the scan and the uncertainty in the time measurements between the clock are also taken into account in operation 814.

A determination is made as to whether the focused uncertainty area is greater than the beam spot size expected based on the beam divergence (operation 816). If the focused uncertainty area is greater than the beam spot, the transmitting satellite directs the laser beam to scan the focused uncertainty area (operation 818). In this example, the scan speed enables at least five TMI per aperture crossing.

The receiving satellite detects the laser beam in a manner that allows determining the location of the transmitting satellite (operation 820). The process terminates thereafter.

With reference again to operation 816, if the focused uncertainty area is equal to or less than the beam spot for the laser beam, the transmitting satellite directs the laser beam to the location of the receiving satellite using the adjusted timestamp angle (operation 822). The process then proceeds to operation 820 as described above.

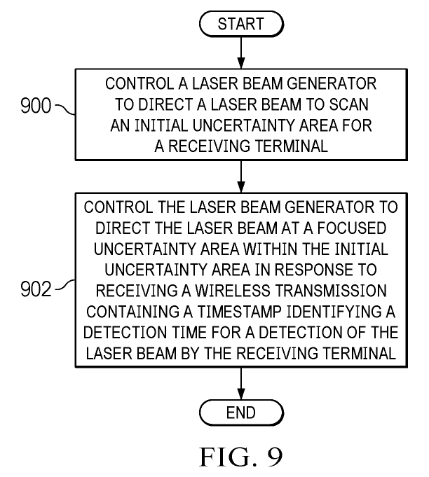

Turning next to FIG. 9, an illustration of a flowchart of a process for directing a laser beam is depicted in accordance with an illustrative embodiment. The process in FIG. 9 can be implemented in hardware, software, or both. When implemented in software, the process can take the form of program instructions that are run by one of more processor units located in one or more hardware devices in one or more computer systems. For example, the process can be implemented in controller 214 in computer system 212 in FIG. 2.

The process controls a laser beam generator to direct a laser beam to scan an initial uncertainty area for a receiving terminal (operation 900). The process controls the laser beam generator to direct the laser beam at a focused uncertainty area within the initial uncertainty area in response to receiving a wireless transmission containing a timestamp identifying a detection time for a detection of the laser beam by the receiving terminal (operation 902). The process terminates thereafter.

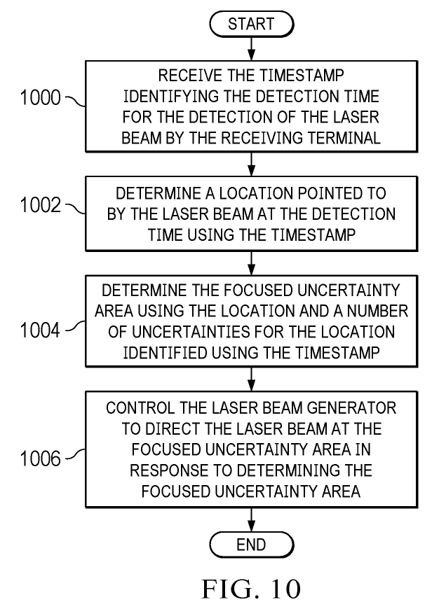

With reference to FIG. 10, an illustration of a flowchart of a process for controlling a laser beam generator to direct a laser beam at a focused uncertainty area is depicted in accordance with an illustrative embodiment. The process in this figure is an example of an implementation for operation 902 in FIG. 9.

The process receives the timestamp identifying the detection time for the detection of the laser beam by the receiving terminal (operation 1000). The process determines a location pointed to by the laser beam at the detection time using the timestamp (operation 1002).

The process determines the focused uncertainty area using the location and a number of uncertainties for the location identified using the timestamp (operation 1004). The number of uncertainties can be selected from at least one of a clock synchronization error, a point-ahead-error, a gimbal jitter, or other suitable uncertainty.

The process controls the laser beam generator to direct the laser beam at the focused uncertainty area in response to determining the focused uncertainty area (operation 1006). The process terminates thereafter.

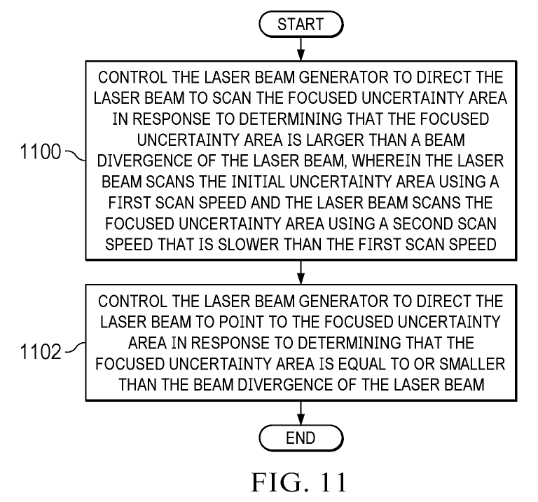

Turning next to FIG. 11, an illustration of a flowchart of a process for directing a laser beam at a focused uncertainty area is depicted in accordance with an illustrative embodiment. The operation in this flowchart is an example of an implementation for operation 1002 in FIG. 10.

The process controls the laser beam generator to direct the laser beam to scan the focused uncertainty area in response to determining that the focused uncertainty area is larger than a beam divergence of the laser beam, wherein the laser beam scans the initial uncertainty area using a first scan speed and the laser beam scans the focused uncertainty area using a second scan speed that is slower than the first scan speed (operation 1100). In operation 1100, the laser beam scans the initial uncertainty area using a first scan speed and the laser beam scans the focused uncertainty area using a second scan speed that is slower than the first scan speed. The first scan speed is sufficient to enable a single detection of the laser beam. The second scan speed is selected to enable the number of detections needed to determine the direction from which the laser beam originated. In this example, the scan speed can be selected to enable at least five detections of the laser beam.

The process controls the laser beam generator to direct the laser beam to point to the focused uncertainty area in response to determining that the focused uncertainty area is equal to or smaller than the beam divergence of the laser beam (operation 1102). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

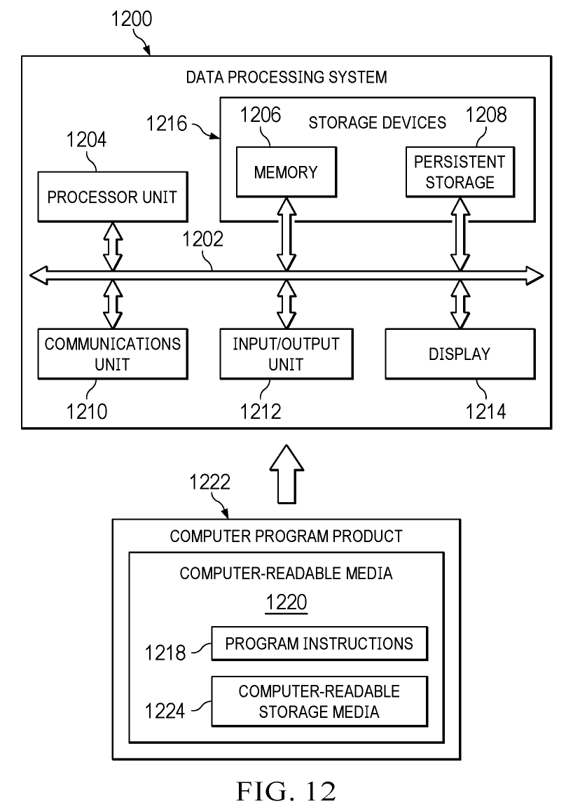

Turning now to FIG. 12, an illustration of a block diagram of a data processing system is depicted in accordance with an illustrative embodiment. Data processing system 1200 can be used to implement computer system 212 and computer system 233 in FIG. 2. Data processing system 1200 can also be used to implement data computing systems or devices for communications terminals depicted for communications network 100 in FIG. 1 and in the satellites depicted in FIGS. 3 and 5. Data processing system 1200 can also be used to implement computer system 212 in FIG. 2. In this illustrative example, data processing system 1200 includes communications framework 1202, which provides communications between processor unit 1204, memory 1206, persistent storage 1208, communications unit 1210, input/output (I/O) unit 1212, and display 1214. In this example, communications framework 1202 takes the form of a bus system.

Processor unit 1204 serves to execute instructions for software that can be loaded into memory 1206. Processor unit 1204 includes one or more processors. For example, processor unit 1204 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1204 can be implemented using one or more heterogeneous processor systems in which a main processor is present with secondary processors on a single chip. As another illustrative example, processor unit 1204 can be a symmetric multi-processor system containing multiple processors of the same type on a single chip.

Memory 1206 and persistent storage 1208 are examples of storage devices 1216. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1216 may also be referred to as computer-readable storage devices in these illustrative examples. Memory 1206, in these examples, can be, for example, a random-access memory or any other suitable volatile or non-volatile storage device. Persistent storage 1208 may take various forms, depending on the particular implementation.

For example, persistent storage 1208 may contain one or more components or devices. For example, persistent storage 1208 can be a hard drive, a solid-state drive (SSD), a flash memory, a rewritable optical disk, a rewritable magnetic tape, or some combination of the above. The media used by persistent storage 1208 also can be removable. For example, a removable hard drive can be used for persistent storage 1208.

Communications unit 1210, in these illustrative examples, provides for communications with other data processing systems or devices. In these illustrative examples, communications unit 1210 is a network interface card.

Input/output unit 1212 allows for input and output of data with other devices that can be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs can be located in storage devices 1216, which are in communication with processor unit 1204 through communications framework 1202. The processes of the different embodiments can be performed by processor unit 1204 using computer-implemented instructions, which may be located in a memory, such as memory 1206.

These instructions are referred to as program instructions, computer usable program instructions, or computer-readable program instructions that can be read and executed by a processor in processor unit 1204. The program instructions in the different embodiments can be embodied on different physical or computer-readable storage media, such as memory 1206 or persistent storage 1208.

Program instructions 1218 are located in a functional form on computer-readable media 1220 that is selectively removable and can be loaded onto or transferred to data processing system 1200 for execution by processor unit 1204. Program instructions 1218 and computer-readable media 1220 form computer program product 1222 in these illustrative examples. In the illustrative example, computer-readable media 1220 is computer-readable storage media 1224.

Computer-readable storage media 1224 is a physical or tangible storage device used to store program instructions 1218 rather than a medium that propagates or transmits program instructions 1218. Computer-readable storage media 1224 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits / lands formed in a major surface of a disc, or any suitable combination thereof.

Computer-readable storage media 1224, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1218 can be transferred to data processing system 1200 using a computer-readable signal media. The computer-readable signal media are signals and can be, for example, a propagated data signal containing program instructions 1218. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1220” can be singular or plural. For example, program instructions 1218 can be located in computer-readable media 1220 in the form of a single storage device or system. In another example, program instructions 1218 can be located in computer-readable media 1220 that is distributed in multiple data processing systems. In other words, some instructions in program instructions 1218 can be located in one data processing system while other instructions in program instructions 1218 can be located in one data processing system. For example, a portion of program instructions 1218 can be located in computer-readable media 1220 in a server computer while another portion of program instructions 1218 can be located in computer-readable media 1220 located in a set of client computers.

The different components illustrated for data processing system 1200 are not meant to provide architectural limitations to the manner in which different embodiments can be implemented. In some illustrative examples, one or more of the components may be incorporated in or otherwise form a portion of, another component. For example, memory 1206, or portions thereof, may be incorporated in processor unit 1204 in some illustrative examples. The different illustrative embodiments can be implemented in a data processing system including components in addition to or in place of those illustrated for data processing system 1200. Other components shown in FIG. 12 can be varied from the illustrative examples shown. The different embodiments can be implemented using any hardware device or system capable of running program instructions 1218.

Thus, illustrative examples provide an apparatus, system, and computer program product for directing a laser beam. In one or more of the examples, a method directs a laser beam scan for a receiving terminal. A laser beam generator is controlled to direct the laser beam to scan an initial uncertainty area for a receiving terminal. The laser beam generator is controlled to direct the laser beam at a focused uncertainty area within the initial uncertainty area in response to receiving a wireless transmission containing a timestamp identifying a detection time for a detection of the laser beam by the receiving terminal.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A laser communications system comprising:
a transmitting terminal comprising:
a laser beam generator configured to transmit a laser beam;
a receiver configured to receive a wireless transmission; and
a controller configured to perform operations comprising:
controlling the laser beam generator to direct the laser beam to scan an initial uncertainty area for a receiving terminal; and
controlling the laser beam generator to direct the laser beam at a focused uncertainty area within the initial uncertainty area in response to the receiver receiving the wireless transmission containing a timestamp identifying a detection time for a detection of the laser beam by the receiving terminal.

2. The laser communications system of claim 1, wherein in controlling the laser beam generator to direct the laser beam at the focused uncertainty area, the controller is configured to perform the operations comprising:
receiving the timestamp identifying the detection time for the detection of the laser beam by the receiving terminal;
determining a location pointed to by the laser beam at the detection time using the timestamp;
determining the focused uncertainty area using the location and a number of uncertainties for the location identified using the timestamp; and
controlling the laser beam generator to direct the laser beam at the focused uncertainty area in response to determining the focused uncertainty area.

3. The laser communications system of claim 2, wherein the number of uncertainties is selected from at least one of a clock synchronization error, a point-ahead-error, or a gimbal jitter.

4. The laser communications system of claim 1, wherein in controlling the laser beam generator to direct the laser beam at the focused uncertainty area in response to determining the focused uncertainty area, the controller is configured to perform the operations comprising:
controlling the laser beam generator to direct the laser beam to scan the focused uncertainty area in response to determining that the focused uncertainty area is larger than a beam divergence of the laser beam, wherein the laser beam scans the initial uncertainty area using a first scan speed and the laser beam scans the focused uncertainty area using a second scan speed that is slower that the first scan speed; and
controlling the laser beam generator to direct the laser beam to point to the focused uncertainty area in response to determining that the focused uncertainty area is equal to or smaller than the beam divergence of the laser beam.

5. The laser communications system of claim 1, wherein the laser beam scans the initial uncertainty area and focused uncertainty area using a pattern selected from a group comprising a spiral pattern, a raster pattern, and a hexagonal pattern.

6. The laser communications system of claim 1, wherein the wireless transmission is a radio frequency transmission received directly from the receiving terminal.

7. The laser communications system of claim 1, wherein the wireless transmission is a laser beam transmission received from a third terminal in communication with the transmitting terminal transmitting the laser beam and the receiving terminal.

8. The laser communications system of claim 1 further comprising:
the receiving terminal comprising:
a wireless transmitter configured to transmit the wireless transmission;
a laser beam sensor system configured to detect the laser beam transmitted from the transmitting terminal; and
a receiving controller configured to perform receiver operations comprising:
generating the timestamp identifying the detection time for the detection of the laser beam by the receiving terminal in response to the laser beam sensor system detecting the laser beam; and
transmitting the timestamp in the wireless transmission to the receiver for the transmitting terminal.

9. The laser communications system of claim 1, wherein the transmitting terminal and the receiving terminal are connected to a platform selected from a group comprising a mobile platform, a stationary platform, a land-based structure, an aquatic-based structure, a space-based structure, a surface ship, a tank, a personnel carrier, a train, a spacecraft, a space station, a satellite, a high altitude platform system, aircraft, a submarine, an automobile, a power plant, a bridge, a dam, a house, a manufacturing facility, or a building.

10. A receiving terminal comprising:
a wireless transmitter configured to transmit a wireless transmission;
a laser beam sensor system configured to detect a laser beam transmitted from a transmitting terminal; and
a receiving controller configured to perform operations comprising:
generating a timestamp identifying a detection time for a detection of the laser beam from a transmitting terminal in response to the laser beam sensor system detecting the laser beam; and
transmitting the timestamp in the wireless transmission to the transmitting terminal using the wireless transmitter.

11. The receiving terminal of claim 10, wherein the receiving terminal further comprises:
a laser beam generator;
wherein the receiving controller configured to perform the operations comprises:
controlling the laser beam generator to transmit a return laser beam in response to detecting the laser beam in a linear region of the laser beam sensor system.

12. The receiving terminal of claim 10, wherein the wireless transmission is a radio frequency transmission sent directly to the transmitting terminal by the wireless transmitter.

13. The receiving terminal of claim 10, wherein the wireless transmission is a laser beam transmission sent by the wireless transmitter to a third terminal in communication with the transmitting terminal and the receiving terminal.

14. A method for directing a laser beam, the method comprising:
controlling a laser beam generator to direct the laser beam to scan an initial uncertainty area for a receiving terminal; and
controlling the laser beam generator to direct the laser beam at a focused uncertainty area within the initial uncertainty area in response to receiving a wireless transmission containing a timestamp identifying a detection time for a detection of the laser beam by the receiving terminal.

15. The method of claim 14, wherein controlling the laser beam generator to direct the laser beam at the focused uncertainty area comprises:
receiving the timestamp identifying the detection time for the detection of the laser beam by the receiving terminal;
determining a location pointed to by the laser beam at the detection time using the timestamp;
determining the focused uncertainty area using the location and a number of uncertainties for the location identified using the timestamp; and
controlling the laser beam generator to direct the laser beam at the focused uncertainty area in response to determining the focused uncertainty area.

16. The method of claim 15, wherein the number of uncertainties is selected from at least one of a clock synchronization error, a point-ahead-error, or a gimbal jitter.

17. The method of claim 15, wherein directing the laser beam at the focused uncertainty area in response to determining the focused uncertainty area comprises:
controlling the laser beam generator to direct the laser beam to scan the focused uncertainty area in response to determining that the focused uncertainty area is larger than a beam divergence of the laser beam, wherein the laser beam scans the initial uncertainty area using a first scan speed and the laser beam scans the focused uncertainty area using a second scan speed that is slower than the first scan speed; and
controlling the laser beam generator to direct the laser beam to point to the focused uncertainty area in response to determining that the focused uncertainty area is equal to or smaller than the beam divergence of the laser beam.

18. The method of claim 14, wherein the laser beam scans the initial uncertainty area and the focused uncertainty area using a pattern selected from a group comprising a spiral pattern, a raster pattern, and a hexagonal pattern.

19. The method of claim 14, wherein the wireless transmission is a radio frequency transmission received directly from the receiving terminal.

20. The method of claim 14, wherein the wireless transmission is a laser beam transmission received from a third terminal in communication with a transmitting terminal transmitting the laser beam and the receiving terminal.
